(19) United States
(12) Patent Application Publication
(10) Pub. No.: US 2026/0160093 A1
(43) Pub. Date: Jun. 11, 2026

(54) IMPROVEMENTS FOR LOCK ASSEMBLIES

(71) Applicant: Giovanni Laporta, Watford (GB)

(72) Inventor: Giovanni Laporta, Watford (GB)

(21) Appl. No.: 18/439,740

(22) PCT Filed: Aug. 12, 2022
(86) PCT No.: PCT/GB2022/052112

§ 371 Date: Feb. 12, 2024

(30) Foreign Application Priority Data
Aug. 12, 2021 (GB) 2111631.4

(51) Int. Cl. E05B 27/00; E05B 9/04; E05B 15/04; E05B 17/22; E05B 41/00; E05B 65/10

(52) U.S. Cl. CPC E05B 27/0057; E05B 17/22; E05B 27/0003; E05B 41/00; E05B 65/1086; E05B 2009/046; E05B 2015/0406

(57) ABSTRACT

A locking mechanism adapter for a cylinder lock, the cylinder lock having a cylinder lock housing having a first bore for receiving a first rotatable lock driving member for rotation within the first bore and a locking cam which is driveable rotatably by the first rotatable lock driving member to operate a locking mechanism on rotation of the locking cam, the locking cam being received in a recess of the cylinder lock housing, the cylinder lock further having a drive bar extending from the cylinder lock housing, the drive bar being driveable rotatably by the first rotatable lock driving member, the drive bar having a distal end directed away from the cylinder lock housing, the locking mechanism adapter comprising a sleeve configured to be received over the distal end of the drive bar, the sleeve being configured to be driveable rotatably by the drive bar.

### FIELD OF THE INVENTION

The present invention relates to a locking mechanism adapter for a cylinder lock. The invention also relates to a lock assembly comprising a locking mechanism adapter and cylinder lock.

### BACKGROUND TO THE INVENTION

Cylinder locks for locking doors, cabinets and other structures are well known in the art. Cylinder locks typically have a cam that is actuated by a lock driving member which drives the cam and thereby actuates a locking bolt or other locking mechanism for locking a door or other leaf. Two examples of common lock cylinders are the “Euro Profile cylinder” and the “Scandinavian Oval cylinder”. The lock driving member which drives the cam may be a key operated mechanism or a thumbturn mechanism. A drawback with existing cylinder locks is that it is difficult to determine whether the lock is in the locked or unlocked state without manually trying to open the leaf that the cylinder lock is mounted to.

GB2587308 (Laporta) discloses a cylinder lock like that shown in FIG. 1A having, in addition to the locking cam 1 for actuating a locking bolt, a second cam 2 co-axial with the locking cam 1, the second cam 2 being configured to cooperate with lock status indicator 3 for monitoring the locked or unlocked state of the cylinder lock. For example, the second cam may be configured to activate a direction switch mounted adjacent the second cam. The locking cam is located in a first recess in the casing of the cylinder lock and likewise the second cam is located in a second recess in the casing of the cylinder. The doors that cylinder locks may be installed in come in many different widths between their external and internal faces. A problem with such cylinder locks is that many different sizes of lock cylinder are required to be manufactured to allow installers to select the correct size to suit the different possible door widths. This requires suppliers to stock many different sizes of cylinder lock.

### SUMMARY OF THE INVENTION

According to a first aspect of the invention there is provided a locking mechanism adapter for a cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the cylinder lock further having a drive bar extending from the cylinder lock housing, the drive bar being driveable rotatably by the first rotatable lock driving member, the drive bar having a distal end directed away from the cylinder lock housing, the locking mechanism adapter comprising a sleeve configured to be received over the distal end of the drive bar, the sleeve being configured to be driveable rotatably by the drive bar.

The adapter provides the advantage of allowing a single size of cylinder lock to be easily installed in a leaf, irrespective of the width of the leaf. In preferred embodiments, the adapter can also be used to monitor the status of the lock. The drive bar can be sized to suit the width of the leaf that the cylinder lock and locking mechanism adapter are to be installed in. The drive bar is the only part of the assembly which needs to be sized to suit the leaf width, therefore the other parts such as the cylinder lock and adapter, can each be provided in standard lengths irrespective of the width of the leaf. When assembled, the locking mechanism adapter is preferably co-axial with the locking cam and the drive bar for rotation therewith. As the lock bar rotates, driven by the first rotatable lock driving member, the locking mechanism adapter is carried by the lock bar and therefore rotates therewith. The adapter may also be referred to as a cylinder lock adapter.

Preferably the adapter has a protrusion extending radially therefrom, the protrusion being adapted to be operatively associated with a lock status indicator for indicating the locked or unlocked state of the cylinder lock.

The adapter with protrusion extending therefrom effectively acts as a second cam of the assembly when the adapter is assembled to the cylinder lock. The protrusion of the adapter forms provides a protruding nib, alike a cam lobe. The protrusion of the locking mechanism adapter is preferably configured to be aligned with a lock mechanism engaging protrusion of the locking cam such that both protrusions are aligned as the locking cam and locking mechanism adapter rotate.

Preferably the sleeve has a proximal end and a distal end, the proximal end being an open end for receiving the drive bar therethrough and the distal end being a closed end.

Preferably the locking mechanism adapter further includes a bias apparatus that biases the locking mechanism adapter away from the cylinder lock housing.

Preferably the bias apparatus may be a compression spring. In preferred embodiments the compression spring is a helical compression spring, also known as a coil compression spring.

Preferably the locking mechanism adapter is configured for coupling to a thumbturn. This allows the thumbturn to drive the lock.

According to a further aspect of the invention there is provided an assembly comprising a drive bar mountable to extend from a cylinder lock housing of a cylinder lock, the cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the drive bar being driveable rotatably by the first rotatable lock driving member, the drive bar having a distal end directed away from the cylinder lock housing, the assembly further comprising a locking mechanism adapter according to any aspect as described herein.

According to a further aspect of the invention there is provided a lock assembly comprising a cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the cylinder lock further having a drive bar extending from the cylinder lock housing, the drive bar being driveable rotatably by the first rotatable lock driving member, the drive bar having a distal end directed away from the cylinder lock housing, the lock assembly further comprising a locking mechanism adapter according to any aspect as described herein.

Preferably the lock assembly further comprises a retaining apparatus for preventing the locking mechanism adapter from being withdrawn from the drive bar.

Preferably the retaining apparatus is configured for mounting on a leaf of a door or window, the locking mechanism adapter comprising a flanged collar extending radially from the sleeve, the retaining apparatus having an opening for receiving the sleeve therethrough, the opening being configured to overlie the flanged collar so as to prevent the sleeve from being withdrawn from its position on the drive bar.

The retaining apparatus may be a simple lock cylinder guard for mounting to the window or door or may be a cover plate, the cover plate preferably further comprising an opening for receiving the nose portion of a handle for the door or window therethrough.

Preferably the drive bar has a longitudinal axis, the drive bar comprising a plurality of partial cuts transverse to its longitudinal axis and spaced out along its longitudinal axis. The drive bar can therefore be easily cut to a suitable length to match the width of the leaf in which it is to be mounted.

Preferably the assembly comprises a plurality of drive bars of differing lengths such that a drive bar can be selected having a length to suit the width of the leaf in which it is to be mounted.

Preferably the sleeve has a hollow bore and the drive bar has a cross-sectional shape configured such that it can key with the hollow bore. The locking mechanism adapter is therefore caused to rotate when the drive bar rotates and vice versa. The drive bar is preferably a spindle having a square shaped cross-section. The drive bar may alternatively be an elongate planar blade, the hollow of the sleeve being shaped to receive the blade therein.

Preferably the lock assembly further comprises a thumbturn couplable to the locking mechanism adapter such that rotation of the locking cam can be driven by rotation of the thumbturn.

Preferably the lock assembly further comprises lock status indicating apparatus operatively associated with the locking mechanism adapter for indicating the locked or unlocked state of the cylinder lock. The lock status indicating apparatus is suitably actuated by rotation of the protrusion of the adapter.

Preferably the lock status indicating apparatus comprises a cam follower which is moveable due to movement of the locking mechanism adapter. The cam follower suitably moves in response to rotation of the protrusion of the adapter. At least part of the lock status indicating apparatus is preferably visible in use to visually indicate the locked or unlocked state of the cylinder lock.

Preferably a portion of the cam follower is visible in use, whereby movement of the locking mechanism adapter causes the portion of the cam follower which is visible to alter in order to visually indicate the locked or unlocked state of the cylinder lock.

Preferably the lock status indicating apparatus includes a sensor that senses the direction of movement of the locking mechanism adapter. The sensor is preferably configured to sense rotation of the protrusion of the adapter.

Preferably the sensor comprises a direction switch configured to output a first detection signal corresponding to a first movement direction of the locking mechanism adapter and a second detection signal corresponding to a second movement direction of the locking mechanism adapter. The direction switch is preferably configured to be actuated by rotation of the protrusion of the adapter.

Preferably the sensor comprises first and second sensors, each of the sensors adapted to sense the movement of the locking mechanism adapter as it moves past the respective sensor, the first and second sensors being arranged adjacent one another such that when the locking mechanism adapter rotates in a clockwise direction the first sensor and then the second sensor will sense the locking mechanism adapter sequentially and when the locking mechanism adapter rotates in an anti-clockwise direction, the second sensor then the first sensor will sense the locking mechanism adapter sequentially. In such embodiments, preferably the sensor comprises first and second switches.

Preferably the lock assembly further comprising a processor adapted to provide an output indicating the direction of rotation of the locking mechanism adapter.

The sensor is preferably configured to generate an output indicating the locked or unlocked state of the cylinder lock and the lock assembly further comprises wireless transmission apparatus to send the output signal to receiver apparatus associated with a status indicator.

In preferred embodiments the lock assembly further comprises a user interface. In preferred embodiments the lock assembly further comprises a memory. The sensor is preferably battery powered.

Preferably the lock assembly further comprises a panic switch, the panic switch being activatable by moving the locking mechanism adapter translationally. For example, the assembly may be configured such that the panic switch is activated by moving the locking mechanism adapter towards the lock cylinder housing (e.g. by pushing the thumbturn), or alternatively is activated by moving the locking mechanism adapter away from the lock cylinder housing (e.g. by pulling the thumbturn).

Preferably the locking mechanism adapter comprises a flanged collar extending radially from the sleeve, the lock assembly comprising a first switch contact on the flanged collar and a second switch contact arranged facing the first switch contact, the first switch contact being biased away from the second switch contact. The panic switch can be operated by pushing the thumbturn in order to engage the first switch contact with the second switch contact.

Preferably the flanged collar of the locking mechanism adapter is made of a conducting material. The first switch contact is therefore integral with the flanged collar of the locking mechanism adapter.

Preferably the lock assembly further comprises a lock block configured to be mountable to a cover plate mounted to the leaf of a door or window, the cover plate having side walls and the lock block being configured to grip the sidewalls of the cover plate via an interference fit. The mounting of the lock block to the assembly prevents the rotatable elements within the cylinder lock which are usually driveable by a key from the outside from rotating, thereby preventing the cylinder lock from being unlocked from the outside.

Preferably the cylinder lock is a euro cylinder lock.

According to a further aspect of the invention there is provided a lock assembly kit, the lock assembly kit comprising a cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the lock assembly kit further comprising a locking mechanism adapter according to any aspect described herein, the cylinder lock further comprising either (i) a drive bar having a longitudinal axis, the drive bar comprising a plurality of partial cuts transverse to its longitudinal axis and spaced out along its longitudinal axis or (ii) a plurality of drive bars of differing lengths such that a drive bar can be selected having a length to suit the width of the leaf in which it is to be mounted, wherein said drive bar or any one of said plurality of drive bars may be assembled to extend from the cylinder lock housing, the drive bar being driveable rotatably by the first rotatable lock driving member, the drive bar having a distal end directed away from the cylinder lock housing.

According to a further aspect of the invention there is provided a method of installing a lock assembly according to any aspect described above, the method comprising providing a lock assembly comprising cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the lock assembly further comprising a locking mechanism adapter according to any aspect described herein, the cylinder lock further comprising either
(i) a drive bar, the method further comprising cutting the drive bar to a suitable length to suit the width of the leaf in which it is to be mounted or
(ii) a plurality of drive bars of differing lengths, the method further comprising selecting a drive bar of length to suit the width of the leaf in which it is to be mounted;
   the method further comprising assembling said cut or selected drive bar to extend from the cylinder lock housing, the drive bar being driveable rotatably by the first rotatable lock driving member, the drive bar having a distal end directed away from the cylinder lock housing. The method may further include placing the lock assembly, once assembled, in an opening in a leaf.

References herein to mounting of any first element to any second element encompass direct or indirect mounting (e.g. the mounting of the first element to a third element which is mounted to the second element).

It is to be understood that the mere use of the term “first” does not require that there be any “second,” and the mere use of the term “second” does not require that there be any “third,” etc.

The term “proximal” as used herein relates to a part closer to a point of origin or other reference than a “distal” part.

### BRIEF DESCRIPTION OF THE DRAWINGS

Embodiments of the invention will now be described by way of example only, with reference to the accompanying drawings, in which:

FIG. 1A shows a prior art cylinder lock;

FIG. 1B shows a prior art cylinder lock assembly including lock status indicator;

FIG. 2 shows an exploded view of a lock assembly according to an embodiment of the present invention;

FIG. 3A shows a perspective view of the lock assembly of FIG. 2, only partially exploded;

FIG. 3B shows a close-up of part of the FIG. 3A assembly;

FIG. 3C shows a further close-up view of part of the FIG. 3A assembly;

FIG. 4A shows a perspective view of the lock assembly of FIG. 2, only partially exploded;

FIG. 4B shows the FIG. 4A assembly, but with the outer cover plate mounted over the inner cover plate;

FIG. 4C shows a close-up of part of the FIG. 4A assembly;

FIG. 5A shows a perspective view of the lock assembly of the lock assembly of FIG. 2, partially exploded to show the lock status indicator;

FIG. 5B shows a close-up of part of the FIG. 5A assembly;

FIG. 5C shows a close-up front view of the lock status indicator while the lock is being converted to its unlocked state;

FIG. 5D shows a close-up front view of the lock status indicator in a neutral position;

FIG. 5E shows a close-up front view of the lock status indicator while the lock is being converted to its locked state;

FIG. 6A shows a close-up front view of the lock status indicator;

FIG. 6B shows a perspective view of the lock status indicator mounted to the inner cover plate, part of the inner cover plate cut away to show the panic button feature;

FIG. 6C shows the assembly of FIG. 6B with the adapter depressed in order to activate the panic button feature;

FIG. 7A shows a perspective exploded view of the lock assembly including a thumbturn cover exploded from the assembly;

FIG. 7B shows the FIG. 7A assembly with the thumbturn cover mounted to the cover plate;

FIG. 7C shows an exploded view of the FIG. 7A assembly with the thumbturn cover partially cut away.

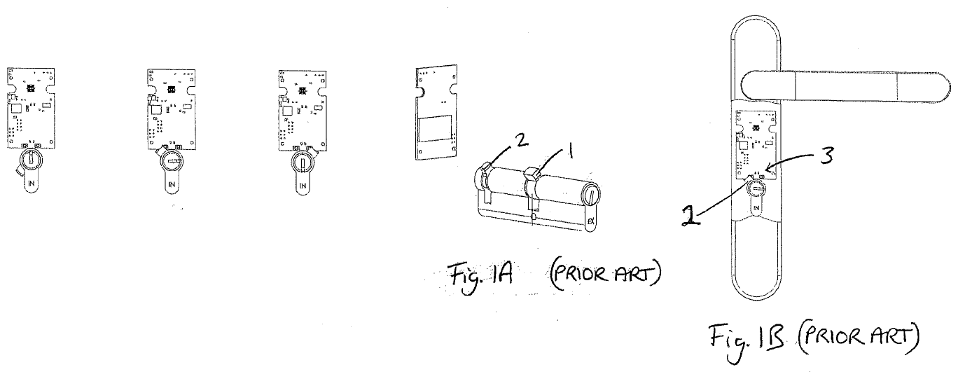

### DESCRIPTION OF THE PREFERRED EMBODIMENTS

The present embodiments represent currently the best ways known to the applicant of putting the invention into practice. But they are not the only ways in which this can be achieved. They are illustrated, and they will now be described, by way of example only. Common features between the assemblies of the different figures are referenced by common reference numerals.

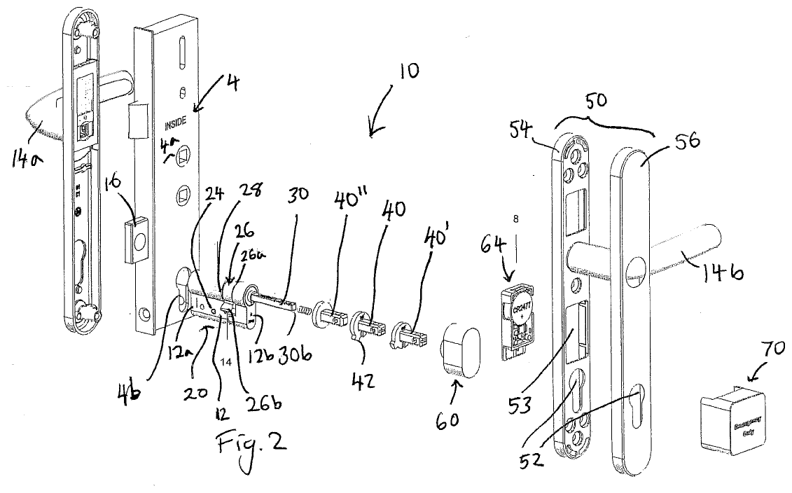

Referring to FIG. 2, an exploded lock assembly 10 is shown including a cylinder lock 12. The particular cylinder lock shown in the figures is a Euro Profile cylinder, although it will be appreciated that the present invention is not limited to a Euro Profile cylinder lock. The cylinder lock 12 has two ends, the longitudinal profile of the cylinder lock extending therebetween. Where the cylinder lock 12 is to be installed in an external leaf, one end 12a is an external end, to face externally when installed, and the other end 12b is an internal end, to face internally when installed. The lock cylinder 12 is part of a lock assembly for locking a leaf such as a door. This lock assembly is also part of a larger assembly which also comprises an external handle grip 14a and an internal handle grip 14b.

Referring to FIG. 2, the cylinder lock 12 comprises a housing 20 which defines a first bore at its external end 12a within which is mounted a first rotatable lock driving member (not visible in the figures). The first rotatable lock driving member is a lock drum comprising a pin tumbler locking mechanism, defining a keyhole and actuatable by a key (not shown) as known in the art and which will not be described further. Instead of a key operated lock drum, the rotatable lock driving member may be hand-operated, for example comprising a “thumbturn” mechanism, as is well-known in the art.

The cylinder lock 12 has a mounting hole 24 provided in a transverse direction through the cylinder lock 12 to receive securing apparatus, such as a bolt, to secure the cylinder lock to a leaf to which it is to be installed, as is known in the art.

The cylinder lock 12 includes a locking cam 26 co-axial with and connectable to the first rotatable lock driving member for rotation therewith. The locking cam 26 is received in a recess 28 in the cylinder lock housing 20. The locking cam 26 has a generally cylindrical body or hub 26a and has a radially projecting protrusion as a cam lever 26b. Rotation of the first rotatable lock driving member causes the locking cam 26 to rotate, thereby actuating a locking bolt/latch 16 of a lock device 4 for locking the leaf. The locking cam 26 is located partway between the internal end 12b and the external end 12a of the cylinder lock 12. The lock device 4 has a housing 4a having an opening 4b for receiving the cylinder lock 12 therethrough.

The cylinder lock 12 has a drive bar 30 extending from its internal end 12b. It will be understood that the assembly could be rearranged so that the drive bar 30 extends from the external end 12a of the cylinder lock 12. The drive bar 30 is co-axial with and connected (directly or indirectly) to the first rotatable lock driving member such that rotation of the first rotatable lock driving member drives rotation of the drive bar 30. The drive bar 30 has a proximal end 30a and a distal end 30b, the distal end 30b extending away from the cylinder lock 12. The drive bar 30 is connected to the cylinder lock 12 by suitable connection apparatus, such as a circlip.

The lock assembly 10 further comprises a locking mechanism adapter 40. In certain embodiments the locking mechanism adapter allows the locked or unlocked status of the cylinder lock to be monitored. The locking mechanism adapter 40 comprises a sleeve 41 configured to be received over the distal end 30b of the drive bar 30. The adapter 40 is configured to be driveable rotatably by the drive bar 30 when assembled thereto. Similarly rotation of the sleeve 41 will drive rotation of the drive bar 30. The adapter 40 allows the number of lock assemblies that need to be stocked for accommodating different possible door widths to be reduced, as will be described.

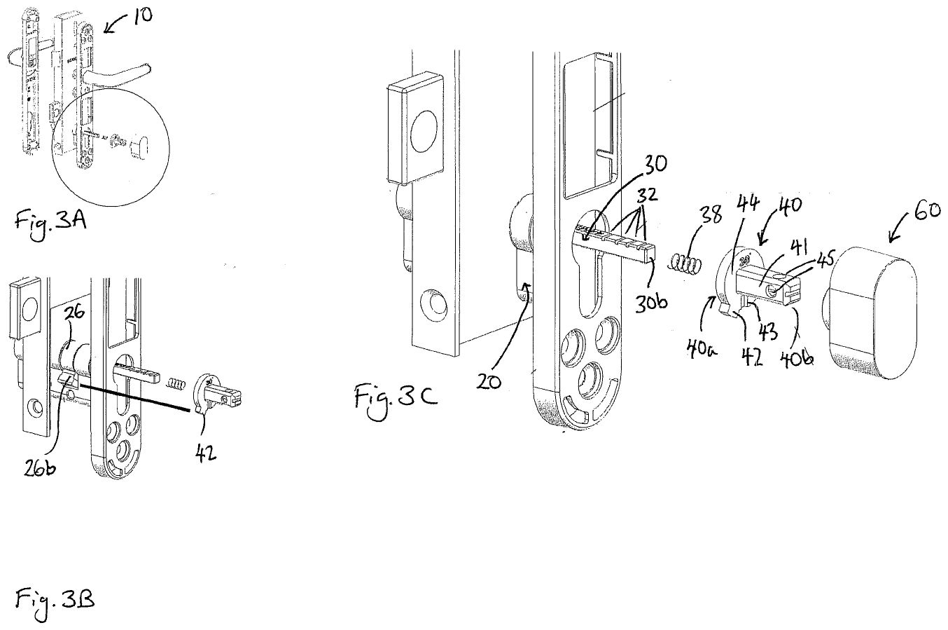

Referring to FIG. 3C, the adapter 40 has a proximal end 40a and a distal end 40b, the proximal end 40a being an open end for receiving the drive bar 30 therethrough and the distal end 40b being a closed end. The sleeve 41 of the adapter comprises an elongate body having a hollow bore, the cross-sectional shape of the drive bar 30 and the hollow bore of the sleeve 41 being such that they are keyed so that when assembled, if one is rotated, the other is caused to rotate. In the embodiment shown in the figures the drive bar 30 and the hollow bore of the sleeve 41 have matching square keying cross-sections.

The adapter 40 comprises a flanged collar 44 extending radially from the sleeve 41. The adapter 40 also has a protrusion or nib 42 extending radially from the sleeve 41, beyond the flanged collar 44. The protrusion 42 is adapted to be operatively associated with lock status indicator apparatus for indicating the locked or unlocked state of the cylinder lock. In the present embodiment, the collar 44 comprises a full ring encircling the sleeve 41, however it will be understood that the collar 44 may only partially encircle the sleeve 41. The collar 44 extends radially from the proximal end 40a of the adapter and the protrusion 42 extends radially from the collar.

The lock assembly further comprises a thumbturn 60 which couples to the adapter 40 when assembled. The thumbturn 60 is rotationally fixed to the adapter 40 such that rotation of the thumbturn 60 rotates the adapter 40 (and thereby rotates the drive bar 30 and the locking cam 26 in order that the lock can be driven by the thumbturn 60. The thumbturn can therefore be used to operate the locking bolt 16. In the present embodiments the thumbturn 60 is an oval shaped knob, however it may be other shapes. The thumbturn mounts to the adapter 40 via a quick-release mechanism wherein ball bearings (not visible in the figures) mounted in an attachment recess in the thumbturn 60 are receivable in slots 45 in the distal end 40b of the adapter 40. This allows the thumbturn 60 to be easily attached and detached from the adapter 40. Other means for attaching the thumbturn 60 to the adapter 40 may be employed.

When assembled, the first rotatable lock driving member, locking cam 26, drive bar 30, adapter 40 and thumbturn 60 are rotatably fixed relative to one another such that rotation of the first rotatable lock driving member causes rotation of the locking cam 26, drive bar 30, adapter 40 and thumbturn 60 and rotation of the thumbturn 60 causes rotation of at least the adapter 40, drive bar 30 and locking cam 26.

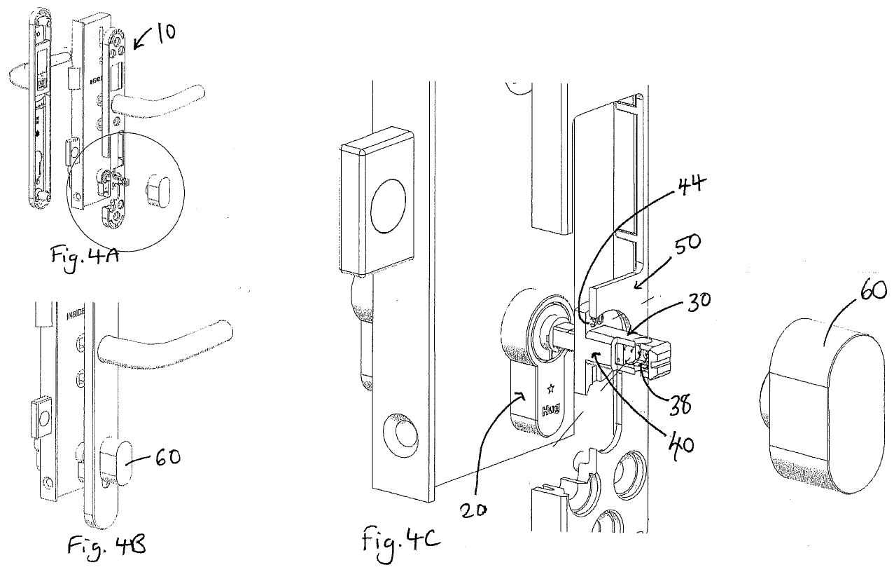

The lock assembly further includes an optional bias apparatus such as a compression spring 38 that biases the adapter 40 away from the cylinder lock housing 20. While optional, the bias apparatus gives rise to certain advantages as will be described. The compression spring 38 is a helical compression spring, however it will be understood that other types of compression spring may be employed. Referring to FIG. 4C, the compression spring 38 is received within the hollow bore of the sleeve 41, at its distal end 40b, such that the compression spring 38 is retained between the closed end 40b of the sleeve 41 and the distal end 30b of the drive bar 30. The compression spring 38 biases the sleeve 41 away from the cylinder lock housing 20, against a retaining apparatus for preventing the locking mechanism adapter from being withdrawn from the drive bar 30. In this embodiment the retaining apparatus is in the form of a cover plate 50 for mounting to the leaf. The cover plate 50 has an opening 52 for receiving the sleeve 41 therethrough, the opening being configured to overlie the edges of the flanged collar so as to prevent the adapter 40 from being withdrawn from its position on the drive bar 30. The compression spring 38 therefore assists in retaining the adapter 40 in position.

The drive bar 30 is elongate, having a longitudinal axis parallel with the longitudinal axis of the cylinder lock 20 when assembled. The drive bar 30 has a plurality of partial cuts 32 transverse to its longitudinal axis. The partial cuts 32 are spaced apart in the region of the distal end 30b of the drive bar. In the present embodiment the partial cuts 32 are spaced apart equally along the drive bar, however they can have non-uniform spacings. The partial cuts 32 comprise cuts into the surface of the drive bar, which do not pass all the way through the drive bar. The partial cuts 32 allow the drive bar 30 to be easily cut to suit different leaf widths. A cutting tool may be used to fully cut the drive bar 30 down to the desired size, the pre-cut partial cuts 32 facilitating the re-sizing. In this way the drive bar 30 provides an adjustable keyway adapter which can be cut to suit different leaf widths. In embodiments in which a bias apparatus is received in the sleeve between the distal end of the drive bar 30 and the closed end of the sleeve, the dimension that the drive bar 30 is cut to does not need to be so accurate as embodiments without a bias apparatus, as the lack of accuracy of length can be compensated for by the bias apparatus.

By means of cutting the drive bar down to size, the lock cylinder 12 does not need to be manufactured in multiple different lengths between its external end 12a and internal end 12b to suit different door widths. Instead, the variable length drive bar 30 which attaches to the thumbturn via the adapter 40 can accommodate different leaf widths.

In other embodiments, instead of cutting the drive bar 30 down to suit the width of the leaf that the assembly is to be installed in, the lock assembly may be provided with a plurality of drive bars of differing lengths, so that a drive bar of suitable length to suit a particular leaf width may be selected.

The lock assembly may further comprise a lock status indicator that indicates the locked or unlocked state of the cylinder lock, which will now be described. Rotation of the first rotatable lock driving member causes the locking cam 26 to rotate, thereby actuating a locking bolt/latch 16 in a lock device 4 for locking the leaf. Rotation of the first rotatable lock driving member also causes the adapter 40 to rotate in the same direction and at the same rate as the locking cam 26. The cylinder lock 20 and lock device 4 are configured such that rotation of the locking cam 26 in a first direction causes the locking bolt 16 to be deactivated (i.e. converted to an unlocked state) and rotation of the locking cam 26 in the opposite direction causes the locking bolt 16 to be activated (i.e. converted to a locked state). Use of the lock status indicator to monitor the direction of rotation of the adapter 40 can therefore provide information on whether the locking bolt is in a locked or an unlocked state. Other locks may have different locking sequences. For example, in certain cylinder locks rotation of the locking cam in a first direction causes the locking bolt to be deactivated with a first rotation of the locking cam and then a lock latch to be deactivated (i.e. a spring-loaded latch to be retracted) by a second rotation of the locking cam and rotation of the locking cam in the opposite direction has the inverse effect (i.e. the lock latch is activated by a first rotation, releasing the spring-loaded latch, and then the deadbolt is activated by a second rotation). A monitoring system can be configured to cooperate with the lock status indicator apparatus to monitor the locking sequence of the particular lock it is to be used with.

The embodiment shown in the figures employs an electronic lock status indicator. An advantage of electronic lock status indicating indicator is that the lock status can be transmitted to a remote user display such as a user interface, such that a user can check the lock status remotely. The electronic lock status indicator may be a sensor that senses the direction of rotation of the adapter 40, such as a direction sensor to sense the protrusion 42 of the adapter 40 sweeping past the direction sensor.

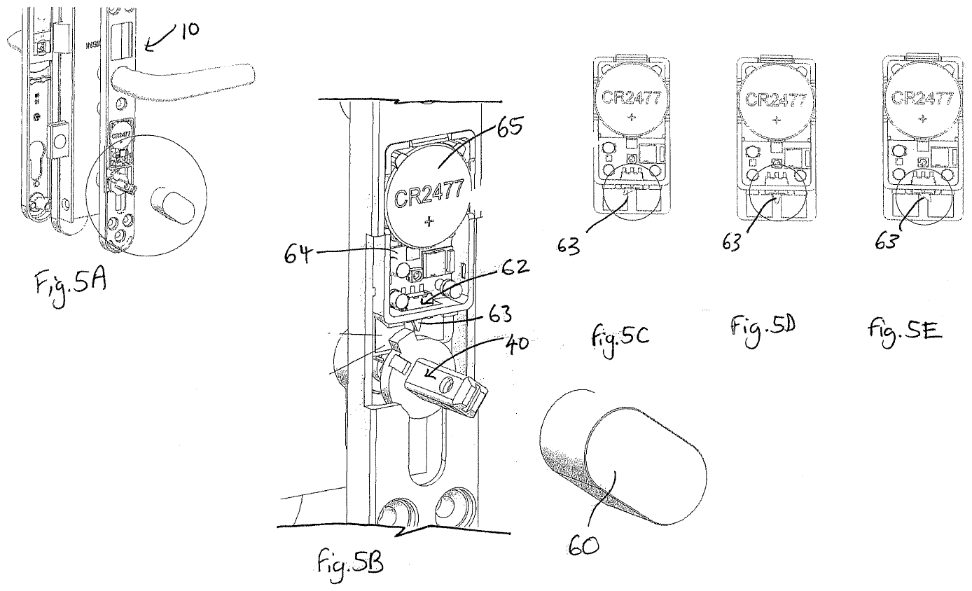

Referring to FIGS. 5A to 5E, the sensor for sensing direction of rotation of adaptor 40 in this embodiment is a direction switch 62. The direction switch 62 has a pivotable toggle or lever 63 which is pivoted by rotation of the adapter 40 to actuate the switch. The direction switch 62 is mounted to a printed circuit board (PCB) 64, mounted to the cover plate 50 such that the lever 63 is positioned in the rotational path of the protrusion 42 such that the protrusion 42 displaces the lever 63 as the adapter 40 rotates between its locked and unlocked states. In this embodiment the direction switch 62 is a momentary (ON)-OFF-(ON) single pole double throw (SPDT) switch, i.e. a lever switch in which the lever returns to the central, neutral, off position when released. In this embodiment, anti-clockwise rotation of the locking cam 26 converts the locking bolt 16 to its unlocked state and clockwise rotation of the locking cam 26 converts the locking bolt 16 to its locked state (as viewed from the internal side of the leaf). Referring to FIG. 5C, anti-clockwise rotation of the locking cam 26 causes the adapter 40 to rotate anti-clockwise. As the adapter 40 rotates in the anti-clockwise direction the protrusion 42 deflects the lever 63 in a first direction (to the left). Referring to FIG. 5D, the lever 63 is configured to return to its centred position once the protrusion 42 has passed the lever 63. Referring to FIG. 5E, as the adapter 40 rotates in the clockwise direction the protrusion 42 deflects the lever 63 in a second direction (to the right). The PCB 64 includes processor adapted to provide an output indicating the direction of rotation of the adapter 40 depending on which direction the lever 63 has been deflected, which thus indicates the locked or unlocked state of the lock.

The PCB 64 includes wireless transmission apparatus, such as RF transmission apparatus, to send the lock status signal to a receiver such that the lock status can be used as part of a wider monitoring system and/or displayed on a user display such as a smartphone, remote control or other device which can receive data, preferably also having a user interface.

In preferred embodiments like that shown in the figures the protrusion 42 of the adapter 40 is configured to be aligned with the cam lever 26b of the locking cam 26. Similarly the switch lever 63 is roughly aligned with a locking cam engagement lever (not shown in the figures) in the lock device 4, such that when the locking cam engagement lever is deflected by the locking cam 26 to lock/unlock the lock device 4, the switch lever 63 will also be deflected. In this way the locking status can easily be monitored. In other embodiments the protrusion 42 of the adapter 40 may be misaligned from the cam lever 26b, however further calibration of the system may be needed in order to monitor the lock status.

Adapters can be provided having the protrusion 42 arranged at a different angle relative to a reference line 43 on the flanged collar 44 of the adapter. Adapter 40 shown in FIG. 3C for example has its protrusion 42 arranged at 30° to the reference line 43. Adapter 40 is designed to be used with a locking cam 26 which has a cam lever 26b arranged at the same angle relative to the vertical when installed in the lock. Referring to FIG. 2, an alternative adapter 40′ may for example be provided wherein the protrusion 42 is arranged at 60° to the reference line 43, to match a locking cam with a cam lever at the same alignment. Adapters with protrusions at other angles may be provided depending on the design of the locking cam. FIG. 2 also shows a further alternative adapter 40″ which is like the adapter 40, however adapter 40″ has no protrusion. Adapter 40″ may be used in the lock assembly when no monitoring of the locking status is desired. For the avoidance of doubt, it will be understood that only one adapter 40, 40′, 40″ will be included in the lock assembly; three different adapters are shown in FIG. 2 to display possible options. Whilst the adapter 40″ with no protrusion does not allow for monitoring of the status of the lock like adapters 40 and 40′ does, all of the adapters shown in the figures, including adapter 40″, allow the number of lock assemblies that need to be stocked for accommodating different possible door widths to be reduced.

The electronic lock status indicator is battery powered by a battery 65 mounted to the PCB 64. The electronic lock status indicator may be powered in other suitable ways.

Other types of electronic lock status indicators may be employed. For example, instead of a direction switch 62, the PCB may have first and second sensors mounted to sense movement of the protrusion 42 as it moves past the sensors. The processor will provide a different output depending on which order the sensors are activated (i.e. depending on which direction the adapter is rotating).

Mechanical lock status indicating apparatus may be employed instead of electronic lock status indicating apparatus. For example, a cam follower which is moveable in response to movement of the protrusion 42 may be provided, the cam follower having first and second indicia thereon to indicate a locked or unlocked state of the cylinder lock, the first or second indicia being visible through a viewing aperture in the assembly depending on the lock status.

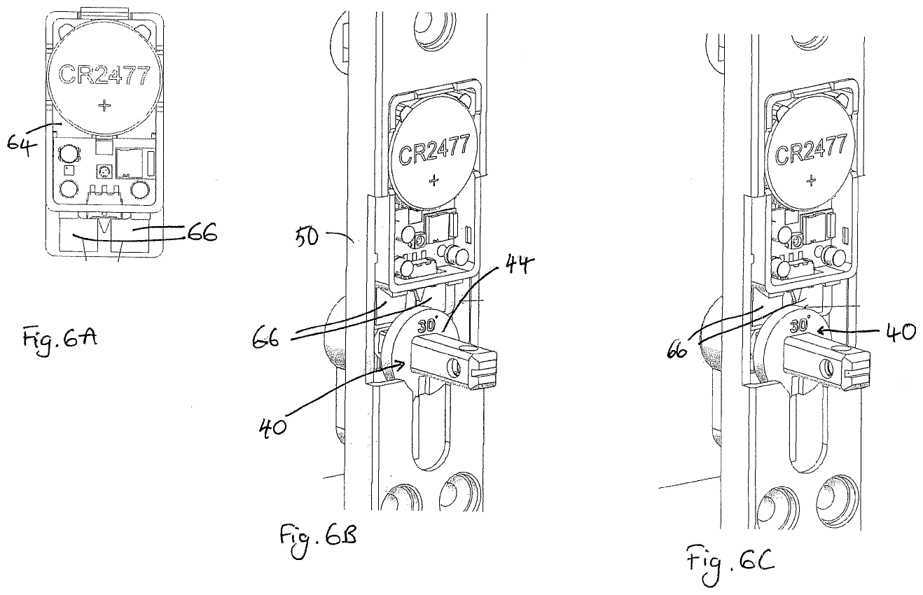

Embodiments having an electronic lock status indicator can be configured to include a panic button feature. Referring to FIGS. 6A to 6C, the flanged collar 44 of the adapter 40 has a first switch contact (not visible in the figures) on its surface facing the leaf when installed. A second contact is mounted directly or indirectly to the leaf such that displacement of the adapter 40 translationally brings the first and second switch contacts into engagement. The system is configured to enter an alert mode when the switch contacts are brought into engagement. Preferably the system will be configured to enter alert mode when the switch contacts are brought into engagement for more than a predetermined duration (for example more than 5 seconds). When the system is in alert mode the system may be caused to activate an output device to indicate that the system is in alert mode, such as an audible alarm. The predetermined time for pushing the switch to enter alert mode should be long enough that alert mode is not entered. The panic button feature may be used as a fire alarm or panic alarm.

The first switch contact on the adapter 40 may be integral with the adapter i.e. if the adapter is made of a conducting material. Alternatively, the adapter 40 may be made of a non-conducting material, such as plastic, but have a conducting surface applied to the surface of the flanged collar 44 which faces towards the leaf when installed to act as the first switch contact. The first switch contact substantially encircles the sleeve 41, such that the first contact can engage the second contact when the adapter is depressed, whatever the angular position of the adapter. In the present embodiment the second switch contact comprises a pair of discrete electrical contacts mounted to the PCB 64 such that when the adapter 40 is depressed, the first switch contact and the second switch contact 66 will engage. The user activates the panic button by depressing the thumbturn 60 towards the leaf to cause engagement of the switch contacts.

The cover plate 50 comprises an inner cover plate 94 and an outer cover plate 56. The inner cover plate 54 has an aperture 53 configured to receive the PCB 64. The outer cover plate 56 mounts over the inner cover 54, both being mountable to the leaf using suitable fixing apparatus, the outer cover 56 forming a protective cover over the PCB 64.

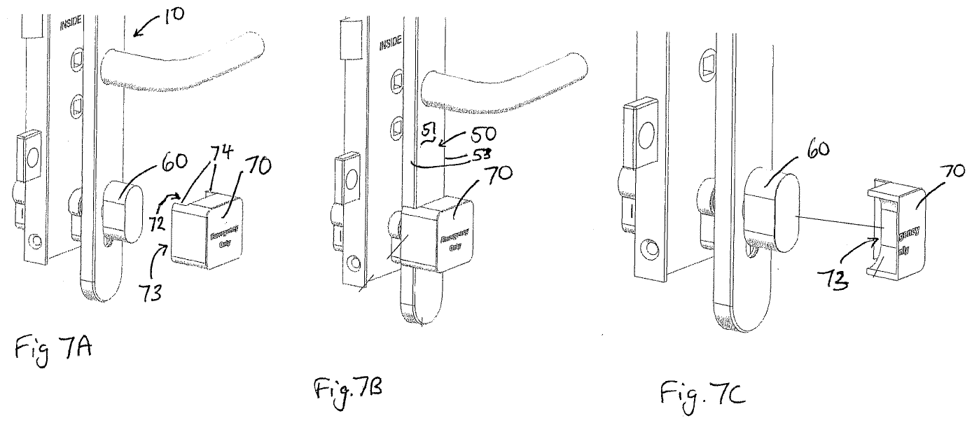

Referring to FIGS. 7A to 7C, the thumbturn comprises an oval shaped knob. The thumbturn is releasably mountable to the adapter 40. A lock block 70 may be provided to prevent the lock from being unlocked from the outside. The lock block 70 is releasably mountable to the assembly. In the present embodiment, in order to mount the lock block 70, the thumbturn 60 is removed and the lock block 70 is then mounted to the distal end of the assembly in place of the thumbturn 60. In other embodiments the lock block 70 may be configured to be received over the thumbturn 60 while the thumbturn 60 is still mounted to the distal end 40b of the adapter 40. Once mounted to the assembly, the lock block 70 prevents the adapter 40 (and the other rotatable locking elements of the lock assembly) from rotating. When mounted to the assembly, the lock block 70 prevents the lock from being unlocked from the outside. The lock block 70 may be used when the user wants to prevent someone unlocking the lock using a key from the outside.

The lock block 70 is sized and shaped to grip the sidewalls of the cover plate 50 via an interference fit in order to prevent the rotatable locking elements of the cylinder lock from being rotated. In the present embodiment the cover plate 50 mounts to the internal side of the leaf (not shown), the cover plate 50 having an internal surface 51 which lies slightly proud of the internal side of the leaf once mounted thereon, the cover plate 50 having side walls 53 extending between the internal surface 51 of the cover plate and the leaf when mounted thereto. In the present embodiment, side walls 53 of the cover plate 50 are substantially planar, parallel to one another, the side walls 53 extending orthogonally to the internal surface 51 of the cover plate. The side walls 53 may of course be differently configured. The lock block 70 has a proximal side 73 which mounts to the lock assembly, the proximal side including a recess 72 sized and shaped to receive the cover plate 50 therein. The recess 72 has side walls which are configured to grip the side walls of the cover plate 50 via an interference fit, thus retaining the lock block 70 non-rotatably in position over the cover plate 50.

When the user wishes to allow the cylinder lock to be operated from the outside again, the lock block 70 may simply be removed and replaced by the thumbturn 60.

It should be noted that embodiments of the inventions have been described invention have been described herein by way of example only, and that modifications can be made within the scope of the claims. It should be further noted that each of the many advantageous features described above may be employed in isolation, or in combination with any one or more other features.

1. A locking mechanism adapter for a cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the cylinder lock further having a drive bar extending from the cylinder lock housing, the drive bar being driveable rotatably by the first rotatable lock driving member, the drive bar having a distal end directed away from the cylinder lock housing,
the locking mechanism adapter comprising a sleeve configured to be received over the distal end of the drive bar, the sleeve being configured to be driveable rotatably by the drive bar.

2. A locking mechanism adapter according to claim 1, wherein the adapter has a protrusion extending radially therefrom, the protrusion being adapted to be operatively associated with a lock status indicator for indicating the locked or unlocked state of the cylinder lock.

3. A locking mechanism adapter according to claim 1, wherein the sleeve has a proximal end and a distal end, the proximal end being an open end for receiving the drive bar therethrough and the distal end being a closed end.

4. A locking mechanism adapter according to claim 1, wherein the locking mechanism adapter further comprises a bias apparatus that biases the locking mechanism adapter away from the cylinder lock housing.

5. A locking mechanism adapter according to claim 4, wherein the bias apparatus comprises a compression spring.

6. A locking mechanism adapter according to claim 1, wherein the locking mechanism adapter is configured for coupling to a thumbturn.

7. A lock assembly comprising
a cylinder lock, the cylinder lock having a cylinder lock housing having a first bore for receiving a first rotatable lock driving member for rotation within the first bore and a locking cam which is driveable rotatably by the first rotatable lock driving member to operate a locking device on rotation of the locking cam, the locking cam being received in a recess of the cylinder lock housing, the cylinder lock further having a drive bar extending from the cylinder lock housing, the drive bar being driveable rotatably by the first rotatable lock driving member, the drive bar having a distal end directed away from the cylinder lock housing,
the lock assembly further comprising a locking mechanism adapter according to claim 1.

8. A lock assembly according to claim 7, wherein the lock assembly further comprises a retaining apparatus that prevents the locking mechanism adapter from being withdrawn from the drive bar.

9. A lock assembly according to claim 8, wherein the retaining apparatus is configured for mounting on a leaf of a door or window, the locking mechanism adapter comprising a flanged collar extending radially from the sleeve, the retaining apparatus having an opening for receiving the sleeve therethrough, the opening being configured to overlie the flanged collar so as to prevent the sleeve from being withdrawn from its position on the drive bar.

10. A lock assembly according to claim 7, wherein the drive bar has a longitudinal axis, the drive bar comprising a plurality of partial cuts transverse to its longitudinal axis and spaced out along its longitudinal axis.

11. A lock assembly according to claim 7, wherein the assembly comprises a plurality of drive bars of differing lengths such that a drive bar can be selected having a length to suit the width of the leaf in which it is to be mounted.

12. A lock assembly according to claim 7, wherein the sleeve has a hollow bore and the drive bar has a cross-sectional shape configured such that it can key with the hollow bore.

13. A lock assembly according to claim 7, wherein the lock assembly further comprises a thumbturn couplable to the locking mechanism adapter such that rotation of the locking cam can be driven by rotation of the thumbturn.

14. A lock assembly according to claim 7, wherein the lock assembly further comprises a lock status indicator operatively associated with the locking mechanism adapter for indicating the locked or unlocked state of the cylinder lock.

15. A lock assembly according to claim 7, wherein the lock status indicator comprises a cam follower which is moveable due to movement of the locking mechanism adapter.

16. A lock assembly according to claim 15, wherein a portion of the cam follower is visible in use, whereby movement of the locking mechanism adapter causes the portion of the cam follower which is visible to alter in order to visually indicate the locked or unlocked state of the cylinder lock.

17. A lock assembly according to claim 14, wherein the lock status indicator includes a direction sensor for sensing direction of movement of the locking mechanism adapter.

18. A lock assembly according to claim 17, wherein the direction sensor comprises a direction switch configured to output a first detection signal corresponding to a first movement direction of the locking mechanism adapter and a second detection signal corresponding to a second movement direction of the locking mechanism adapter.

19. A lock assembly according to claim 17, wherein the direction sensor comprises first and second sensors, each of the first and second sensors adapted to sense the movement of the locking mechanism adapter as it moves past the respective sensor, the first and second sensors being arranged adjacent one another such that when the locking mechanism adapter rotates in a clockwise direction the first sensor and then the second sensor will sense the locking mechanism adapter sequentially and when the locking mechanism adapter rotates in an anti-clockwise direction, the second sensor and then the first sensor will sense the locking mechanism adapter sequentially.

20. A lock assembly according to claim 17, the lock assembly further comprising a processor adapted to provide an output indicating the direction of rotation of the locking mechanism adapter.
